(19) United States
(12) Patent Application Publication
(10) Pub. No.: US 2026/0243489 A1
(43) Pub. Date: Aug. 20, 2026

(54) ICE SHAVER

(71) Applicant: Albert Ming Hwa Wang, Syosset, NY (US)

(72) Inventors: NAIHUA CHEN, Fuzhou (CN); YE CHEN, Fuzhou (CN); MINGYUE ZHENG, Fuzhou (CN)

(73) Assignee: Albert Ming Hwa Wang, Syosset, NY (US)

(21) Appl. No.: 19/248,937

(22) Filed: Jun. 25, 2025

(30) Foreign Application Priority Data
Feb. 14, 2025 (CN) 202520237573X
Feb. 14, 2025 (CN) 2025202374794

(51) Int. Cl. F25C 5/12

(52) U.S. Cl. CPC F25C 5/12

(57) ABSTRACT

An ice shaver includes a main machine, a first accommodation cylinder with a cutting blade, and a press-to-rotate assembly. During use, ice cubes are placed in the first accommodation cylinder, and then the press-to-rotate assembly is quickly assembled to shave ice. In addition, a second accommodation cylinder can be included to replace the press-to-rotate assembly for placing the ice cubes, and a spiral blade in the second accommodation cylinder can be used to rotate and guide the ice cubes to shave ice, thereby expanding the application range of the ice shaver.

### FIELD OF THE INVENTION

The present invention relates the field of ice shavers, and more particularly relates to an ice shaver that is used to press and rotate an ice cube for ice shaving, and the ice shaver can be quickly mounted on a main machine to improve the ease of use.

### BACKGROUND OF THE INVENTION

Ice shaver is a device that can shave ice cubes or frozen fruits into the form of snowflakes. For example, an ice shaving machine disclosed in U.S. Pat. No. 9,451,850 B2 has a basic structure including a main machine, a fixed platform or an accommodation cylinder arranged on the main machine for placing an ice block, and a turntable, wherein the bottom of the fixed platform or accommodation cylinder is provided with a plurality of cutting blades and a gap, and users can manually operate the handle to press the turntable down on the ice block that is placed on the fixed platform or accommodation cylinder, so that the bottom of the ice block is pressed downward against the cutting blade. When the main machine drives the turntable to rotate, the ice block rotates relative to the cutting blade and is shaved into ices in the form of snowflakes, which then fall down from the gap at the bottom of the platform or accommodation cylinder, thereby completing the production of shaved ice.

In another ice shaver of a different structure as disclosed in U.S. Pat. No. 7,134,620B1, the ice shaver is also provided with a fixed base with a cutting blade at the bottom on a main machine. The fixed base is used to flexibly accommodate a rotary container with a spiral blade inside. In addition, the rotary container is driven by a drive device of the main machine to rotate relative to the fixed base and the cutting blade. In use, small ice cubes are placed into the rotary container, and the rotary container is driven to rotate continuously through the main machine. The spiral blade that rotates synchronously can guide the small ice cubes to roll down, so that the small ice cubes are cut into the form of snowflakes by the cutting blade.

The above two ice shavers have the following disadvantages. In the design of U.S. Pat. No. 9,451,850B2, the ice block must be manually operated by a handle to push down the turntable and then drive it to rotate, so that the ice block can be cut by the cutting blade, which is very inconvenient to use. In the design of U.S. Pat. No. 7,134,620B1, due to the space limitation of the spiral blade in the rotary container, the rotary container cannot accommodate and guide medium and large ice cubes (such as frozen apples) to roll downward. The users have to first knock the medium and large ice cubes into appropriate sizes before using them.

### SUMMARY OF THE INVENTION

In view of the aforementioned drawbacks of the prior art, the inventor of the present invention improves the pressing and rotating components in the ice shaver, so that the ice block does not need to be pressed down manually during use, thereby overcoming the drawbacks of the prior art. Specifically, the purpose of the invention is to provide an ice shaver with a quick installation kit to improve the convenience of use.

To achieve this purpose, the present invention provides an ice shaver, including:
a main machine, including a socketing seat with a circular inner periphery arranged on the main machine; the circular inner periphery of the socketing seat being provided with an external ring gear, the outer periphery of the external ring gear being provided with an engagement part, which is driven by a drive device in a main machine to rotate the external ring gear on the socketing seat, and the inner periphery of the external ring gear being provided with a snap part exposed from the circular inner periphery of the socketing seat;
a first accommodation cylinder, fixed to the socketing seat, the first accommodation cylinder including a circular open top, a flat bottom plate, and a first accommodation space defined between the top and the bottom plate; wherein the top is fixed to the bottom of the circular inner periphery, and the bottom plate is provided with at least one protruding cutting blade, and a material outlet; and
a press-to-rotate assembly, including a snap element, a flexible telescopic arm extending downward from the snap element, and a nail plate located at the bottom of the flexible telescopic arm; wherein the snap element is detachably snapped to a snap part of the external ring gear, such that the flexible telescopic arm and the nail plate extend downward into a first accommodation space of the first accommodation cylinder to elastically press an ice cube, and when the external ring gear is driven to rotate, the snap relationship between the snap element and the external ring gear allows the press-to-rotate assembly and the downwardly pressed ice cube to rotate relative to the first accommodation cylinder and the cutting blade, so that the ice cube can be cut by the cutting blade and then fall through the material outlet.

In an embodiment, the present invention further includes a second accommodation cylinder, the second accommodation cylinder includes a top and a bottom which are both in a circular open shape, a second accommodation space is formed between the top and the bottom for accommodating an ice cube; wherein the top is provided with at least one snap block detachably snapped to a snap part of the external ring gear, so that the bottom and the second accommodation space are sheathed on the first accommodation cylinder and then to rotate synchronously with the external ring gear, and the second accommodation space contains at least one a spiral blade located above the cutting blade, and when the spiral blade rotates, the ice cube is pushed to displace, and guided downwardly to receive the shaving by the cutting blade before falling down through the material outlet; and

One of the press-to-rotate assembly and the second accommodation cylinder is selectively installed onto the external ring gear. When in use, the ice cube is placed into the first accommodation space of the first accommodation cylinder, and then the press-to-rotate assembly is installed and driven to rotate; or the second accommodation cylinder is installed first, and then the ice cube is placed into the second accommodation cylinder, and finally the second accommodation cylinder is driven to rotate.

Compared with the prior art, U.S. Pat. No. 9,451,850B2, the press-to-rotate assembly in the present invention can be quickly assembled on the main machine without being restricted by the circumferential angle. After the press-to-rotate assembly is driven by the external ring gear, the ice cube can be automatically pressed down and rotated by the flexible telescopic arm and the nail plate, without the need for the manual operation to press down the ice cube, thereby improving the convenience of use.

Furthermore, in some embodiments of the present invention, the second accommodation cylinder can replace the press-to-rotate assembly, so that users can choose to install the press-to-rotate assembly or the second accommodation cylinder according to the size of the ice cube. For example, when a user wants to make snowflake ice from medium and large ice cubes or frozen apples of similar size, the user can directly place the medium and large ice cubes into the first accommodation cylinder and then install the press-to-rotate assembly. The production can be completed by driving the press-to-rotate assembly through the main machine. When the user wants to make snowflake ice from small ice cubes or frozen strawberries of similar size, the user can choose to install the second accommodation cylinder, place the small ice cubes into the second accommodation cylinder and perform shaving, thereby effectively expanding the application scope of the ice shaver and improving the convenience and efficiency of using the ice shaver.

The technical characteristics of the invention will become apparent with the detailed description of preferred embodiments accompanied with the illustration of related drawings.

### BRIEF DESCRIPTION OF THE DRAWINGS

FIG. 1 is an exploded view of an ice shaver of the present invention;

FIG. 2 is a schematic view showing the assembly relationship of a socketing seat, an external ring gear and a first accommodation cylinder of the present invention;

FIG. 3 is a schematic view showing the assembly of an external ring gear and a press-to-rotate assembly of the present invention;

FIG. 4 is a schematic view showing the structure of a press-to-rotate assembly of the present invention;

FIG. 5 is a schematic view showing the snap structure of a press-to-rotate assembly and an external ring gear of the present invention;

FIG. 6 is a schematic view showing the structure of a press-to-rotate assembly installed on a main machine of the present invention;

FIG. 7 is a schematic view showing the structure of a second accommodation cylinder of the present invention;

FIG. 8 is a schematic view showing the snap structure of a second accommodation cylinder and an external ring gear of the present invention;

FIG. 9 is an exploded view a third accommodation cylinder, a press-to-rotate assembly and a first accommodation cylinder of the present invention;

FIG. 10 is a schematic view showing of the assembly of a third accommodation cylinder, a press-to-rotate assembly and a first accommodation cylinder of the present invention.

### DESCRIPTION OF THE PREFERRED EMBODIMENTS

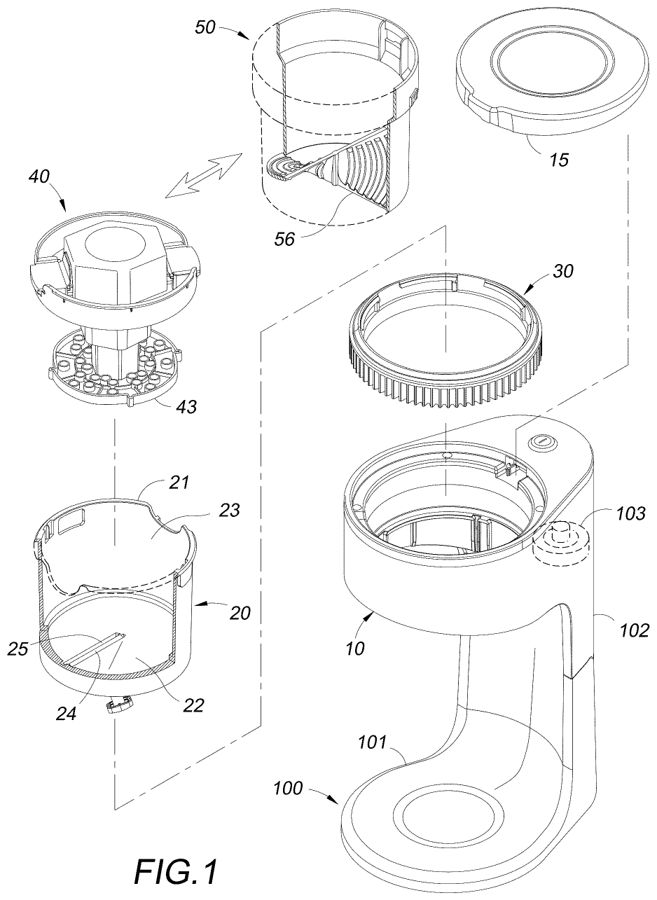

With reference to FIG. 1 for an ice shaver of the present invention, the basic components of the ice shaver include a main machine 100 with a socketing seat 10 at the top, a first accommodation cylinder 20 installed below the socketing seat 10, an external ring gear 30, and a press-to-rotate assembly 40, wherein the external ring gear 30 is rotatably arranged in the socketing seat 10 and located above the first accommodation cylinder 20, and the press-to-rotate assembly 40 is detachably assembled to the inner edge of the external ring gear 30 on the socketing seat 10.

FIG. 1 further shows that a second accommodation cylinder 50 is additionally provided in an embodiment of the present invention. The second accommodation cylinder 50 may replace the press-to-rotate assembly 40, allowing the user to selectively install the press-to-rotate assembly 40 or the second accommodation cylinder 50 in order to shave ice; the second accommodation cylinder 50 is a non-essential accessory for the implementation of the present invention is implemented, and basically only the press-to-rotate assembly 40 needs to be installed for the operation.

The main machine 100 further includes a base 101 located below the socketing seat 10, and a support column 102 disposed between the socketing seat 10 and the base 101. The support column 102 is located on one side of the socketing seat 10 and the base 101, and has a drive device 103 disposed therein adjacent to the external ring gear 30 in the socketing seat 10, and provided for driving the external ring gear 30 to rotate.

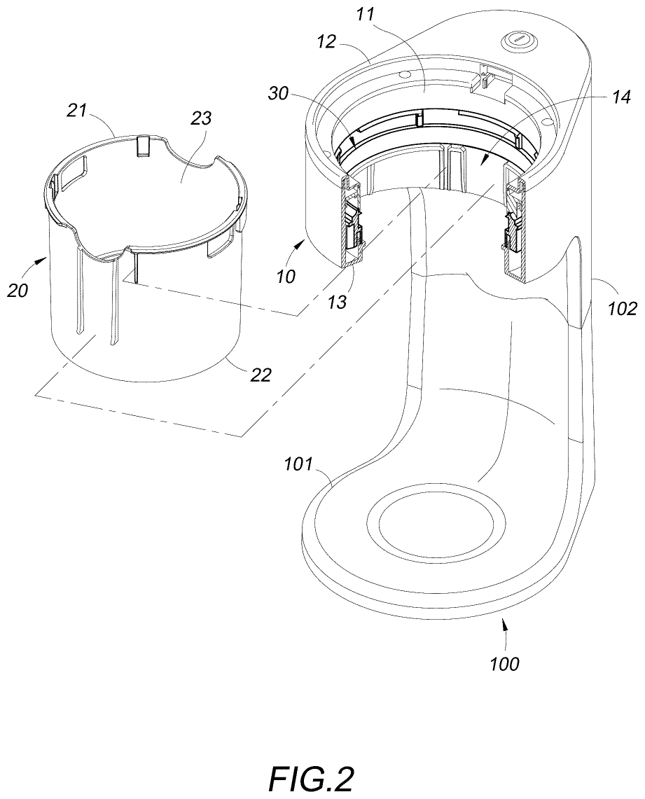

With reference to FIG. 2 for the assembly relationship between the socketing seat 10, the external ring gear 30 and the first accommodation cylinder 20, as shown in FIGS. 1 and 2, the socketing seat 10 has a circular inner periphery 11 with a top 12 and a bottom 13, in which are both in a circular open shape, and the external ring gear 30 is arranged between the top 12 and the bottom 13, and the bottom 13 is provided with a mounting part 14 at a position below the external ring gear 30, and the mounting part 14 is installed with the first accommodation cylinder 20, so that the first accommodation cylinder 20 is fixed below the external ring gear 30.

In an embodiment, the top 12 of the socketing seat 10 is further provided with an upper cover 15 which can be opened and closed to cover the top 12 of the circular inner periphery 11. The upper cover 15 is electrically connected to the drive device 103 and a switch (not shown in the figure). When the upper cover 15 is opened, the switch is disconnected to stop supplying power to the drive device 103. When the upper cover 15 is closed, the switch is turned on to supply power to the drive device 103 and drive the external ring gear 30 to rotate.

The first accommodation cylinder 20 includes a circular top 21 and a flat bottom plate 22, wherein a first accommodation space 23 is formed between the top 21 and the bottom plate 22, the top 21 is assembled and fixed on the mounting part 14 of the socketing seat 10, so that a distance for placing a container is formed between the bottom surface of the bottom plate 22 and the base 101 of the main machine 100, and the bottom plate 22 is provided with at least a protruding cutting blade 24 and a material outlet 25 that passes through the bottom plate 22 from top to bottom. As for the assembly method between the top 21 of the first accommodation cylinder 20 and the mounting part 14 of the socketing seat 10, a plurality of slots and ribs detachably engaged with each other is taken as an example, but the present invention is not limited thereto.

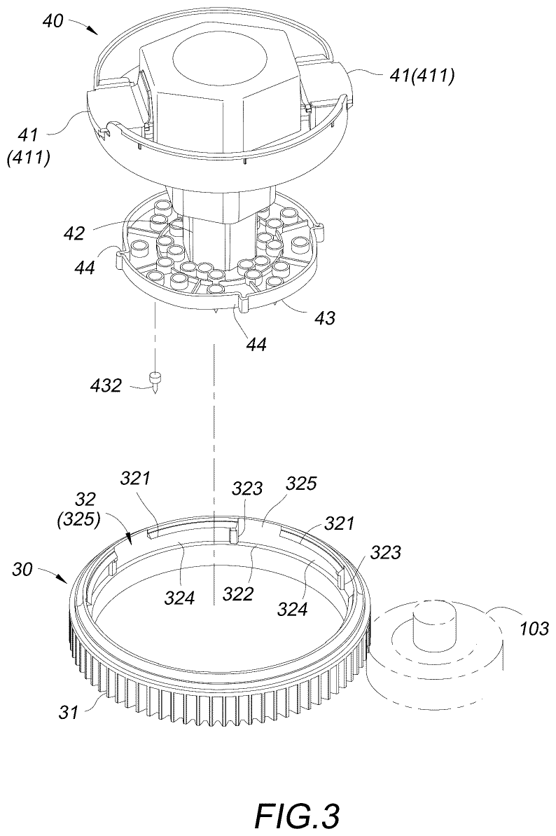

With reference to FIG. 3 for the perspective view of the external ring gear 30, as shown in FIGS. 1 to 3, the outer periphery of the external ring gear 30 is provided with an engagement part 31 hidden in the socketing seat 10, and the inner periphery of the external ring gear 30 is provided with a snap part 32 exposed from the circular inner periphery 11 of the socketing seat 10. The engagement part 31 is driven by the drive device 103 in the main machine 100 to rotate the external ring gear 30 in the socketing seat 10, and the snap part 32 is disassembled and assembled with the press-to-rotate assembly 40 or the second accommodation cylinder 50, so that the press-to-rotate assembly 40 or the second accommodation cylinder 50 and the external ring gear 30 rotate synchronously. As for the engagement part 31 receiving the drive device 103 to drive the rotation, the engagement part 31 can be driven by a motor with a transmission gear, which is a related art and will not be described in detail.

In order to allow the press-to-rotate assembly 40 or the second accommodation cylinder 50 to be assembled and disassembled with the snap part 32 located inside the external ring gear 30, the snap part 32 of the external ring gear 30 includes a plurality of curved ribs 321 protruding inwards and a stop ring 322 located below the plurality of curved ribs 321, wherein the plurality of curved ribs 321 is arranged in a ring-shaped manner, and a longitudinal stop rib 323 is protruding downwards on a side of each curved rib 321, so that the plurality of curved ribs 321, the stop ring 322 and the longitudinal stop rib 323 together constitute a plurality of positioning parts 324, and the distance between every two adjacent curved ribs 321 respectively constitutes a plurality of snap slots 325; wherein the snap slots 325 are provided for the purpose of installing the aforementioned additional second accommodation cylinder 50, but the present invention is not limited thereto.

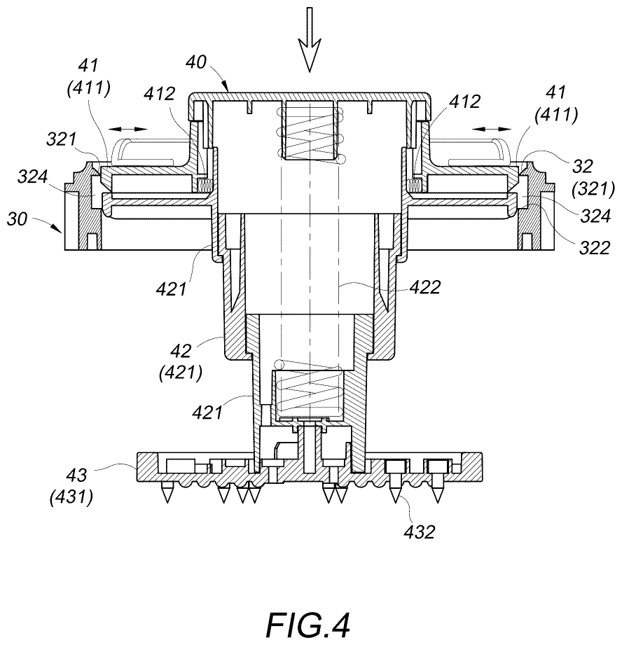

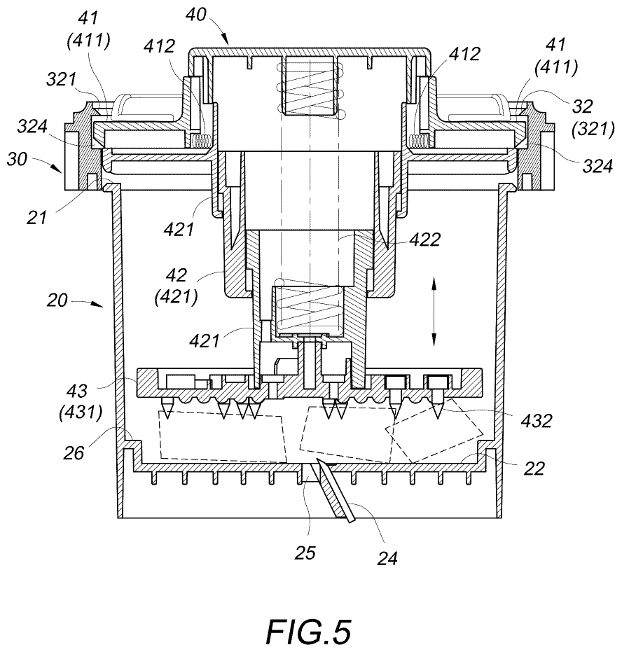

FIG. 4 is a schematic view showing the structure of the press-to-rotate assembly 40, and FIG. 5 is a schematic view showing the snap structure of the press-to-rotate assembly 40 and the external ring gear 30. As shown in FIGS. 1 to 5, the press-to-rotate assembly 40 includes: a snap element 41, a flexible telescopic arm 42 extending downward from the snap element 41, and a nail plate 43 located at the bottom of the flexible telescopic arm 42, wherein the snap element 41 is detachably snapped to the snap part 32 of the external ring gear 30, so that the telescopic arm 42 can be extended and retracted up and down relative to the bottom plate 22 of the first accommodation cylinder 20 to enable the nail plate 43 to be close to or away from the bottom plate 22.

When the snap element 41 of the press-to-rotate assembly 40 is snapped on the snap part 32 of the external ring gear 30, the flexible telescopic arm 42 and the nail plate 43 extend downward into the first accommodation space 23 of the first accommodation cylinder 20, and when the external ring gear 30 is driven to rotate, the press-to-rotate assembly 40 rotates synchronously through the snap structure of the snap element 41 and the snap part 32 of the external ring gear 30.

In some embodiments, the snap element 41 includes two elastic snap blocks 411 that are symmetrical to each other, and two elastic elements 412 that are respectively disposed in the two elastic snap blocks 411, wherein the thickness of the elastic snap blocks 411 is substantially equal to or slightly smaller than the height between the plurality of curved ribs 321 and the stop ring 322 in the snap part 32 of the external ring gear 30, and the elastic elements 412 in the two elastic snap blocks 411 enable the two elastic snap blocks 411 to elastically expand or contract toward each other.

When it is necessary to install the press-to-rotate assembly 40 on the snap part 32 of the external ring gear 30, the flexible telescopic arm 42 and the nail plate 43 are first extended downward into the first accommodation cylinder 20, and then the press-to-rotate assembly 40 is directly pressed downward. At this time, due to the obstruction of the plurality of curved ribs 321, the two elastic snap blocks 411 can be retracted under the elastic action of the elastic element 412. When the two elastic snap blocks 411 respectively pass over the plurality of curved ribs 321, the two elastic snap blocks 411 are elastically stretched outwards through the elastic element 412 to abut between the curved rib 321 and the stop ring 322. Then, the two elastic snap blocks 411 are deflected by an angle, so that a side of the two elastic snap blocks 411 abuts against the longitudinal stop rib 323. Therefore, the two elastic snap blocks 411 are snapped on the positioning part 324 formed by the plurality of curved ribs 321, the stop ring 322 and the longitudinal stop rib 323. When the external ring gear 30 rotates, the press-to-rotate assembly 40 and the external ring gear 30 can rotate synchronously through the engagement relationship between the two elastic snap blocks 411 and the positioning part 324.

To facilitate the assembly and disassembly of the press-to-rotate assembly 40, the cross section of each convex rib 321 is an acute triangle, and the top and bottom surfaces have an inclined angle. Thus, when assembling or disassembling the press-to-rotate assembly 40, it is only necessary to directly apply force downward or upward to make the two elastic snap blocks 411 retract upward or downward over the plurality of ribs 321 and then expand outward, so that the two elastic snap blocks 411 of the press-to-rotate assembly 40 and the snap part 32 of the external ring gear 30 can be assembled or separated from each other.

It is noteworthy that there is no circumferential angle restriction when assembling the press-to-rotate assembly 40. It is only necessary to press the snap element 41 and deflect it by an angle as described above, so that the two elastic snap blocks 411 abut against the longitudinal stop rib 323 to complete the positioning and assembly. In some embodiments, the height of the plurality of ribs 321 protruding inwards may be slightly greater than the longitudinal stop rib 323. If the two elastic snap blocks 411 are retracted downwards over the plurality of ribs 321, and then expanded outwards, they are supported on the longitudinal stop rib 323. The plurality of ribs 321 can prevent the snap element 41 from bouncing upwards above the two elastic snap blocks 411. At this time, the snap element 41 is deflected by an angle, and the two elastic snap blocks 411 can still be elastically expanded outwards against the longitudinal stop rib 323 in order to complete the assembly. In other words, during the assembling of the press-to-rotate assembly 40, there is no need to perform alignment, and only needs to press the press-to-rotate assembly 40 down and deflect an angle, so as to improve the convenience of use.

In order to prevent the press-to-rotate assembly 40 from loosening when assembled with the external ring gear 30, the widths of the two elastic snap blocks 411 are respectively larger than the snap slots 325 of the external ring gear 30, so as to prevent the two elastic snap blocks 411 from loosening upward from the snap slots 325 when no external force is applied.

In some embodiments of the flexible telescopic arm 42 of the press-to-rotate assembly 40, a compression spring 422 may be provided in the two hollow sleeves 421 that are connected up and down, so that the two hollow sleeves 421 can be extended or shortened and a downward elastic force is maintained on the lower nail plate 43, so that the nail plate 43 can be automatically and elastically pressed downward.

The structure of the nail plate 43 includes a flat plate 431 capable of receiving downward pressure from the flexible telescopic arm 42, and a plurality of claw nails 432 disposed on the bottom surface of the flat plate 431, wherein the flat plate 431 is substantially in the shape of a circular disc.

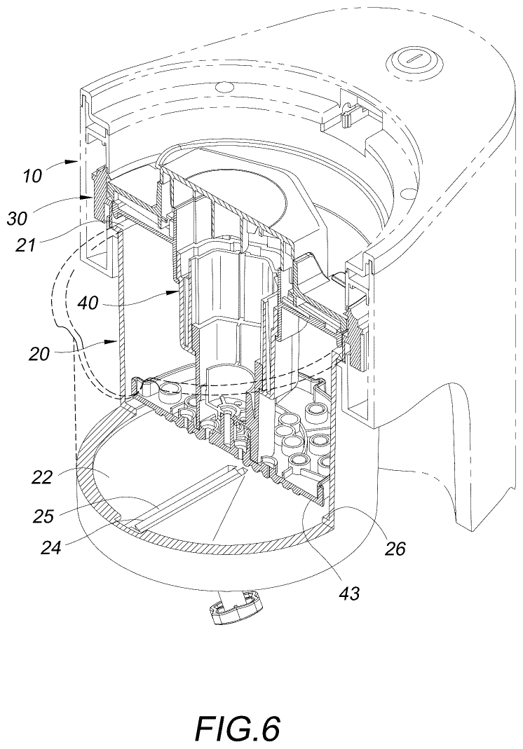

FIG. 6 shows a combination relationship of the socketing seat 10, the first accommodation cylinder 20, the external ring gear 30 and the press-to-rotate assembly 40. As shown in FIGS. 1 and 4 to 6, when the user opens the upper cover 15, places the medium and large ice cubes into the first accommodation space 23 of the first accommodation cylinder 20, installs the press-to-rotate assembly 40 on the external ring gear 30, closes the upper cover 15 and drives the external ring gear 30 to make the press-to-rotate assembly 40 rotate synchronously, the flexible telescopic arm 42 and the nail plate 43 can elastically press the medium and large ice cubes downward, and make the ice cube rotate relative to the cutting blade 24 on the bottom plate 22 of the first accommodation cylinder 20, so that the medium and large ice cubes are shaved by the cutting blade 24 and fall downward from the material outlet 25.

In some embodiments, a limit ring 26 is disposed around the top of the bottom plate 22 of the first accommodation cylinder 20, wherein the inner diameter of the limit ring 26 is smaller than the outer diameter of the flat plate 431 of the nail plate 43, so that the ice cubes placed in the first accommodation cylinder 20 are not pushed to the outer periphery of the nail plate 43, thereby ensuring that the nail plate 43 can press down all the ice cubes.

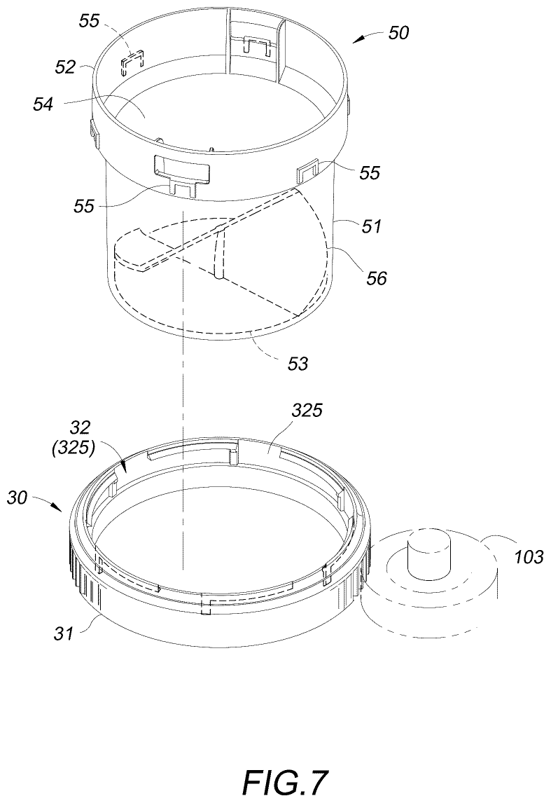

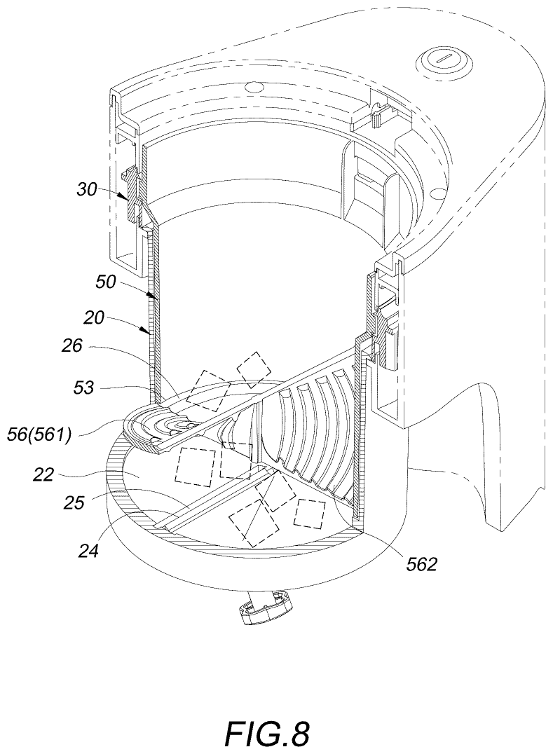

FIGS. 7 and 8 respectively disclose the aforementioned additional kit, namely the structure of the second accommodation cylinder 50, and the snap structure of the second accommodation cylinder 50 and the external ring gear 30. As shown in FIGS. 1, 7 and 8, the second accommodation cylinder 50 includes a cylindrical body 51 having an outer diameter smaller than the inner diameter of the first accommodation cylinder 20, a top 52 having a circular opening shape, an open bottom 53 located at the bottom of the cylindrical body 51, and a second accommodation space 54 located in the cylindrical body 51 and communicating between the top 52 and the bottom 53. The cylindrical body 51 can be inserted into the first accommodation space 23 in the first accommodation cylinder 20, at least one snap block 55 is arranged around the outer periphery of the top 52, and at least one spiral blade 56 is fixedly arranged in the second accommodation space 54.

In conjunction with the aforementioned embodiment of the external ring gear 30, the snap block 55 of the second accommodation cylinder 50 is downwardly embedded into the snap slot 325 of the snap part 32 of the external ring gear 30 to complete the assembly. When the external ring gear 30 rotates, the second accommodation cylinder 50 can be rotated synchronously with the external ring gear 30. In order to remove the second accommodation cylinder 50, we simply lift the second accommodation cylinder 50 upwards to disengage the snap block 55 from the snap slot 325. In this way, the second accommodation cylinder 50 can be detachably assembled to the snap part 32 of the external ring gear 30, or separated from the snap part 32 of the external ring gear 30.

The spiral blade 56 disposed in the second accommodation cylinder 50 is located above the open bottom 53 in an arc-shaped upright state, and includes at least a curved guide bottom surface 561, and a plurality of guide ribs 562 protruding from the guide bottom surface 561.

When the second accommodation cylinder 50 is assembled on the external ring gear 30, the cylindrical body 51 is inserted into the first accommodation cylinder 20, and the small ice cubes are placed in the second accommodation space 54, the small ice cubes can fall through the vertical spiral blade 56 and the open bottom 53 onto the bottom plate 22 of the first accommodation cylinder 20. At this time, the upper cover 15 is closed and the second accommodation cylinder 50 and the spiral blade 56 are synchronously driven to rotate through the external ring gear 30, so that the small ice cubes are pushed and guided downward by the curved guide bottom surface 561 and the plurality of guide ribs 562 of the spiral blade 56, so that the small ice cubes are shaved by the cutting blade 24 of the first accommodation cylinder 20 and fall downward from the material outlet 25.

In conjunction with the aforementioned embodiment in which a switch is turned on when the upper cover 15 is closed, a trigger member (not shown in figures) may be provided on the outside of the second accommodation cylinder 50. When the second accommodation cylinder 50 is inserted into the first accommodation cylinder 20, the trigger member may trigger a micro switch additionally provided around the first accommodation cylinder 20, so that the power supplied to the drive device 103 for driving the external ring gear 30 to rotate can be ensured at the start timing by the dual switch control of the switch of the upper cover 15 and the trigger member of the second accommodation cylinder 50, so as to improve safety.

In conjunction with the embodiment of the limit ring 26 disposed around the upper portion of the bottom plate 22 of the first accommodation cylinder 20, the outer diameter of the bottom 53 of the cylindrical body 51 of the second accommodation cylinder 50 is greater than the inner diameter of the limit ring 26, so that when the second accommodation cylinder 50 rotates, the ice cubes will not be pushed to the outer periphery of the bottom 53 of the cylindrical body 51 of the second accommodation cylinder 50, so as to ensure that the spiral blade 56 can guide all the ice cubes to be shaved by the cutting blade 24.

In summation of the embodiment of the second accommodation cylinder 50 of the present invention, the press-to-rotate assembly 40 or the second accommodation cylinder 50 is selectively installed to the external ring gear 30. When the user wants to make snowflake ice from medium and large ice cubes or frozen fruits in the size of apples, the user can place the ice cubes into the first accommodation cylinder 20, install the press-to-rotate assembly 40, and drive the external ring gear 30 to make the press-to-rotate assembly 40 rotate synchronously, so as to complete the production of snowflake ice. If a small ice cube or frozen fruit in the size of a strawberry is to be made into snowflake ice, the second accommodation cylinder 50 can be installed on the external ring gear 30, and then the small ice cubes are placed into the second accommodation cylinder 50, and the external ring gear 30 is driven to rotate the second accommodation cylinder 50, so as to improve the convenience of use of the ice shaver.

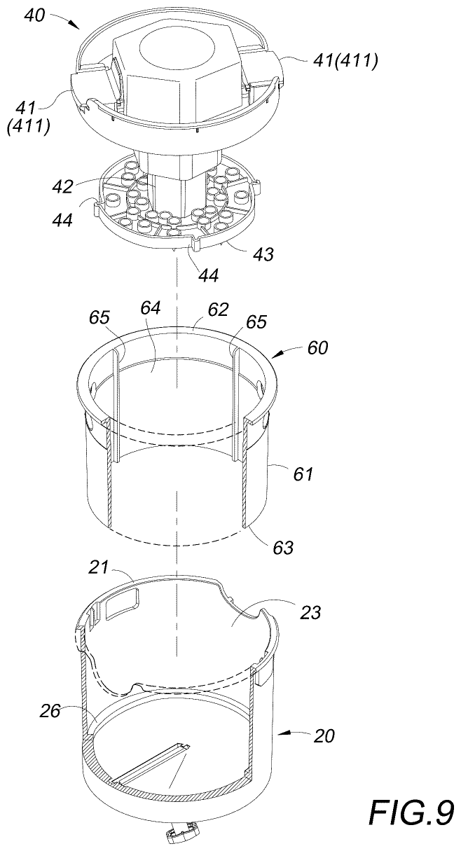

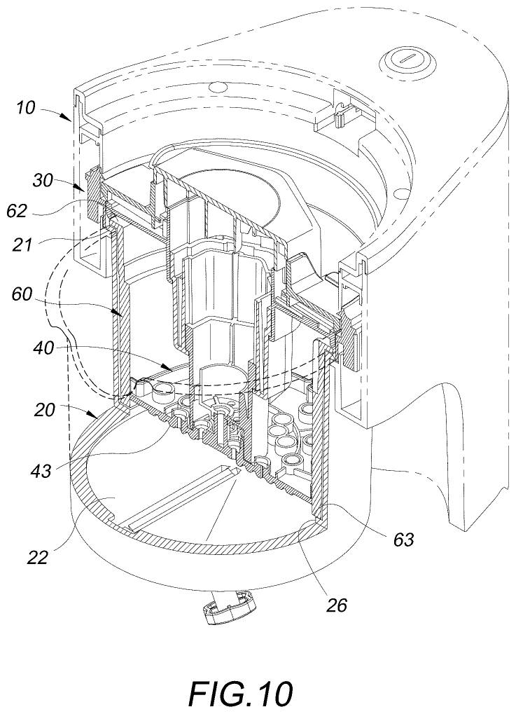

FIGS. 9 and 10 disclose an embodiment of the present invention in which a third accommodation cylinder 60 is additionally provided to match the press-to-rotate assembly 40 and the first accommodation cylinder 20. As shown in the figures, the present invention further includes a third accommodation cylinder 60. The third accommodation cylinder 60 is cylindrical in shape, communicates from top to bottom, and includes a hollow socket 61 that can be movably inserted into the first accommodation cylinder 20, a top 62 protruding outwardly and located at the top of the socket 61, a bottom 63 located at the bottom of the socket 61, and an inner surface 64 located at the inner edge of the socket 61.

In conjunction with the aforementioned embodiment of the first accommodation cylinder 20 and the press-to-rotate assembly 40, the outer diameter of the socket 61 of the third accommodation cylinder 60 is smaller than the inner diameter of the first accommodation cylinder 20, so that the third accommodation cylinder 60 can be flexibly inserted into the first accommodation space 23 of the first accommodation cylinder 20, and the top 62 of the socket 61 protruding outwardly is stacked on the circular top 21 of the first accommodation cylinder 20, so that the bottom 63 of the socket 61 is located above the limit ring 26 around the bottom of the first accommodation cylinder 20.

In addition, the inner surface 64 located at the inner edge of the socket 61 has an inner diameter smaller than the outer diameter of the nail plate 43 of the press-to-rotate assembly 40, so that the nail plate 43 and the telescopic arm 42 of the press-to-rotate assembly 40 can be extended into the socket 61 through the top 62 of the third accommodation cylinder 60 and rotated.

The purpose of the third accommodation cylinder 60 is to allow the nail plate 43 of the press-to-rotate assembly 40 to rotate more smoothly. In some embodiments, a plurality of longitudinal ribs 65 protrudes inwardly from the inner surface 64 of the third accommodation cylinder 60, and a plurality of grooves 44 is provided at corresponding positions on the outer periphery of the nail plate 43. When the press-to-rotate assembly 40 is assembled, so that the nail plate 43 extends downward into the socket 61 of the third accommodation cylinder 60, the plurality of grooves 44 can be inserted into the plurality of longitudinal ribs 65. When the nail plate 43 rotates, the plurality of grooves 44 can be used to press against the longitudinal rib 65, in order to drive the third accommodation cylinder 60 to rotate synchronously.

Therefore, the user can place the socket 61 of the third accommodation cylinder 60 into the first accommodation cylinder 20, put the ice cubes into the socket 61, and let the ice cubes fall onto the bottom plate 22 of the first accommodation cylinder 20. The user can assemble the press-to-rotate assembly 40 to press the ice cubes downward, and close the upper cover 15 (as shown in FIG. 1) on the socketing seat 10 to shave the ice automatically.

The above embodiments and drawings are only examples of preferred embodiments of the present invention, which are not intended to limit the scope of the present invention, numerous modifications and variations could be made thereto by those skilled in the art without departing from the scope and spirit of the invention as set forth in the claims, and any similarities with the purpose, structure, device, feature, etc. of the present invention shall fall within the patent scope of the present invention.

What is claimed is:

1. An ice shaver, comprising:
a main machine, comprising a socketing seat and a drive device; wherein the socketing seat has a circular inner periphery with a top and a bottom, both are in an open state, an external ring gear is movably arranged between the top and the bottom, the external ring gear has an engagement part located outside the periphery and hidden in the socketing seat, the engagement part is driven by the drive device to rotate the external ring gear, and the external ring gear has a snap part located inside the periphery and exposed in the circular inner periphery of the socketing seat;
a first accommodation cylinder, fixed to the socketing seat, the first accommodation cylinder having a circular opening top and a flat bottom plate, the top being fixed to the bottom of the circular inner periphery, the bottom plate comprising a protruding cutting blade and a material outlet, and a first accommodation space being formed between the top and the bottom plate for accommodating an ice cube; and
a press-to-rotate assembly, comprising a plurality of snap elements, a plurality of flexible telescopic arms extending downward from the snap element, and a plurality of nail plates located at the bottom of the flexible telescopic arm; wherein the snap element is detachably snapped on the snap part of the external ring gear, so that the flexible telescopic arm and the nail plate extend downward into the first accommodation space of the first accommodation cylinder to elastically press down the external ice cube, and when the external ring gear is driven to rotate, the press-to-rotate assembly and the pressed ice cube rotate relative to the bottom plate and cutting blade of the first accommodation cylinder through the snap relationship between the snap element and the snap part, so that the ice cube is shaved by the cutting blade and then falls through the material outlet.

2. The ice shaver according to claim 1, wherein the top of the main machine socketing seat is provided with an upper cover which can be opened and closed to cover the top of the circular inner periphery; the upper cover is electrically coupled to the drive device; when the upper cover is opened, the power supplied to the drive device is disconnected; and when the upper cover is closed, the power supplied to the drive device drives the external ring gear to rotate.

3. The ice shaver according to claim 1, wherein the snap part of the external ring gear comprises a plurality of curved ribs respectively protruding inwards and a stop ring located below the plurality of curved ribs, and a plurality of longitudinal stop ribs arranged between the plurality of curved ribs and the stop ring, so that the plurality of curved ribs, the plurality of longitudinal stop ribs and the stop ring together constitute a plurality of positioning parts; and
the snap element of the press-to-rotate assembly comprises two elastic snap blocks which are symmetrical on both sides, and a plurality of elastic elements which press against the two elastic snap blocks respectively to make them elastically expand or retract toward each other, wherein the thickness of the elastic snap block is substantially equal to or slightly smaller than the height and distance between the plurality of curved ribs of the external ring gear and the stop ring, and pressing down the press-to-rotate assembly can make the two elastic snap blocks elastically retract and elastically expand after passing over the plurality of curved ribs, and then deflect an angle to make the two elastic snap blocks respectively press against the longitudinal stop rib, so that the two elastic snap blocks are respectively positioned at the positioning part and synchronously driven to rotate by the external ring gear.

4. The ice shaver according to claim 3, wherein the cross section of each curved rib is an acute triangle for guiding the two elastic snap blocks to elastically expand or retract toward each other.

5. The ice shaver according to claim 1, wherein the flexible telescopic arm of the press-to-rotate assembly comprises two hollow sleeves coupled from top to bottom, and a compression spring installed in the two hollow sleeves, the compression spring is provided for the two hollow sleeves to elastically extend or retract from each other and maintain a downward elastic force on the nail plate, so that the nail plate can automatically elastically press down the ice cube.

6. The ice shaver according to claim 5, wherein the nail plate comprises a flat plate which is substantially disc-shaped and capable of accepting a downward pressure of the flexible telescopic arm, and a plurality of claw nails arranged on the bottom surface of the flat plate.

7. The ice shaver according to claim 1, further comprising a second accommodation cylinder, the second accommodation cylinder comprising a cylindrical body with an outer diameter smaller than the inner diameter of the first accommodation cylinder and capable of being inserted into the first accommodation space of the first accommodation cylinder, and the cylindrical body having a top and a bottom, both in a circular opening shape, and a second accommodation space being formed between the top and the bottom to accommodate the ice cube;
wherein, the top is detachably snapped on the snap part of the external ring gear, so that the cylindrical body can rotate synchronously with the external ring gear, and at least a vertical spiral blade is provided in the second accommodation space, the spiral blade is located above the bottom plate and the cutting blade of the first accommodation cylinder, and capable of pushing the ice cube to move relative to the cutting blade when rotating, and guiding the ice cube downward to be shaved by the cutting blade and then fall through the material outlet; and
the press-to-rotate assembly and the second accommodation cylinder are selectively installed to the external ring gear, when in use, the external ice cube is placed in the first accommodation space of the first accommodation cylinder, the press-to-rotate assembly is installed and driven to rotate; or the second accommodation cylinder is installed and the ice cube is placed therein, and the second accommodation cylinder is driven to rotate.

8. The ice shaver according to claim 7, wherein the snap part of the external ring gear comprises a plurality of curved ribs protruding inwards and a stop ring located below the plurality of curved ribs, and the plurality of curved ribs is arranged in a ring-shaped manner, so that a snap slot is formed between every two adjacent curved ribs; and
a plurality of snap blocks is arranged around the top of the second accommodation cylinder relative to the plurality of snap slots, and when the cylindrical body of the second accommodation cylinder is inserted into the first accommodation cylinder, the plurality of snap blocks can be inserted downward into the snap slots respectively, so that the second accommodation cylinder is fixed on the external ring gear and rotates synchronously with the external ring gear.

9. The ice shaver according to claim 8, wherein the spiral blade of the second accommodation cylinder is arranged above the open bottom in an arc-shaped upright state, and the spiral blade comprises a curved guide bottom surface and a plurality of guide ribs convexly arranged on the guide bottom surface.

10. The ice shaver according to claim 1, further comprising a third accommodation cylinder, the third accommodation cylinder comprising a cylindrical socket communicating from top to bottom, and the socket having a top and a bottom which protrude outward;
wherein, the socket is movably inserted into the first accommodation cylinder, the outwardly protruding top is stacked on the circular top of the first accommodation cylinder, and the bottom of the socket is located above the bottom plate and the cutting blade of the first accommodation cylinder, so that the socket is provided for placing an ice cube and allowing the ice cube to fall on the bottom plate of the first accommodation cylinder; and
the flexible telescopic arm and the nail plate of the press-to-rotate assembly are extended downward into the socket and assembled with the external ring gear, so that the flexible telescopic arm and the nail plate of the press-to-rotate assembly elastically press down the ice cube.

11. The ice shaver according to claim 10, wherein the socket of the third accommodation cylinder has an inner surface located between the top and the bottom, and the inner surface is provided with a plurality of longitudinal ribs protruding inward;
the nail plate of the press-to-rotate assembly comprises a flat plate which is substantially disc-shaped and capable of receiving a downward pressure from the flexible telescopic arm, and a plurality of claw nails arranged on a bottom surface of the flat plate, wherein the flat plate is provided with a plurality of grooves at positions relative to the plurality of longitudinal ribs of the third accommodation cylinder respectively; and
when the nail plate extends downward into the socket, the plurality of grooves can be inserted into the corresponding plurality of longitudinal ribs respectively; and when the external ring gear drives the press-to-rotate assembly to rotate, the plurality of grooves respectively press against the longitudinal ribs to drive the third accommodation cylinder to rotate synchronously.
